(19) United States
(12) Patent Application Publication
(10) Pub. No.: US 2008/0028622 A1
(43) Pub. Date: Feb. 7, 2008

(54) TOOL HANDLE ASSEMBLY HAVING ELECTRICALLY INSULATED HANDLE END PIECE

(76) Inventor: Nicholas D. Trbovich, Orchard Park, NY (US)

Correspondence Address: JAECKLE FLEISCHMANN & MUGEL, LLP, 190 Linden Oaks, ROCHESTER, NY, 14625-2812, US

(21) Appl. No.: 11/462,923

(22) Filed: Aug. 7, 2006

(51) Int. Cl. B25G 3/00

(52) U.S. Cl. 30/342

(57) ABSTRACT

A tool handle assembly and method of electrically insulating a metal tool from a metal handle end piece to which the tool attaches includes an electrically insulating insert providing a gasket-like seal between an extension of the tool which extends through a handle grip and the handle end piece. In another aspect of the invention, a portion of the handle grip surrounds an internal air gap to provide shock absorption which protects the integrity of the water-tight seal between the exterior and interior of the handle assembly.

### BACKGROUND OF THE INVENTION

The present invention relates to tool handle assemblies, and more particularly relates to a tool handle assembly having a handle end piece which is electrically insulated from a metal tool to which the handle assembly attaches.

Many tool handle assemblies have a handle end piece which is used to secure the tool to a handle. The handle, which is shaped for manually grasping and working of the tool, includes a longitudinal opening through which a separate part or extension of the tool extends at one end of the handle. The end piece mounts to the opposite end of the handle and attaches to the tool extension in the handle thereby securing the tool to the handle. In some designs, the tool and end piece are made of metal while the handle is made of an electrically insulating material such as plastic or rubber. Should the tool come into contact with electricity, electric current can travel through the tool extension inside the handle and reach the butt cap thereby shocking the hand of the user.

Attempts to insulate a metal handle end piece from the metal tool have not been entirely successful in that the insulating barriers may fail should the handle assembly become wet. Should water leak past the insulating barrier, an electric circuit is completed between the tool and end piece and the user may receive a shock. Furthermore, many prior art handle assemblies (and thus also the insulating barrier) fail under the cumulative impact stresses which occur through normal use of the tool.

### SUMMARY OF THE INVENTION

In a first aspect, the present invention provides a handle assembly for a metal tool having a metal end piece which is electrically insulated from the tool. The tool may be a knife blade, for example. In one embodiment, an electrically insulating insert is positioned between the metal end piece and a metal extension of the tool extending within an opening in the handle. The engaging surfaces of the insert and end piece firmly secure these two parts together. The tool extension includes a coupling element which attaches to a bore formed in the insert thereby securing the end piece, insert and tool to the handle.

In a second aspect of the invention, a portion of the handle opening is of a larger diameter and thereby radially spaced from the tool extension axially extending through the handle opening. The spacing between the handle and tool extension defines an air gap internally of the handle. The portion of the handle adjacent the air gap is made of a material which can absorb the shock (by flexing, for example) of a force applied to the tool or handle end piece.

In one embodiment of the invention, the tool is a knife blade of the type used by soldiers where cutting through electrified wires is sometimes necessary. In another embodiment of the invention, the end piece may be a butt cap and the but cap may include a pointed end used for breaking glass, for example. In another embodiment, the end piece is a bayonet clip for mounting the knife to a firearm.

### BRIEF DESCRIPTION OF THE DRAWING

FIG. 1 is a perspective view of an embodiment of the invention with the tool shown fragmented;

FIG. 2 is a perspective view of the embodiment of FIG. 1 showing the end piece partly removed from the handle portion;

FIG. 3 is an enlarged, perspective view of the embodiment of the invention of FIGS. 1 and 2 and showing the end piece completely removed from the handle portion;

FIG. 4 is a cross-sectional view as taken generally along the line 4-4 in FIG. 1; and

FIG. 5 is the view of FIG. 1 showing an embodiment wherein the end piece is a bayonet latch.

### DETAILED DESCRIPTION

While the invention will be described with reference to a particular embodiment of the invention, it is understood that many modifications may be made thereto without departing from the full scope of the invention. Some particular modifications will be discussed herein while other modifications will be readily apparent to those skilled in the art.

Referring now to the drawing, there is seen in the various figures an embodiment of the invention in the form of a knife 10 having a blade 12 and a handle assembly 14. Blade 12 may be substituted with other types of tools as desired such as a hammer, screwdriver, file, or awl, for example. The tool or blade 12 is made of a strong metal material which by its nature is electrically conductive. An extension 16 connects to the blade 12 either as a separate or integral part thereof and is also made of a strong metal material which is electrically conductive.

The handle assembly 14 includes a handle grip 18 made of an electrically insulating material such as plastic or rubber, for example. The handle assembly 14 further includes an end piece for securing the handle grip 18 to the knife blade 12 via extension 16. The end piece may take a variety of forms and is preferably formed of a strong metal material which is inherently electrically conductive. In the embodiment of FIGS. 1, 2 and 4, the end piece is in the form of a butt cap 20. But cap 20 may include a pointed end 20a which can be used for breaking glass, for example. This embodiment of knife 10 is particularly suited for pilots that may need to break through a downed aircraft windshield, for example. In the embodiment of FIG. 5, the end piece is in the form of a bayonet latch 23 for attaching knife 10 to a firearm (not shown).

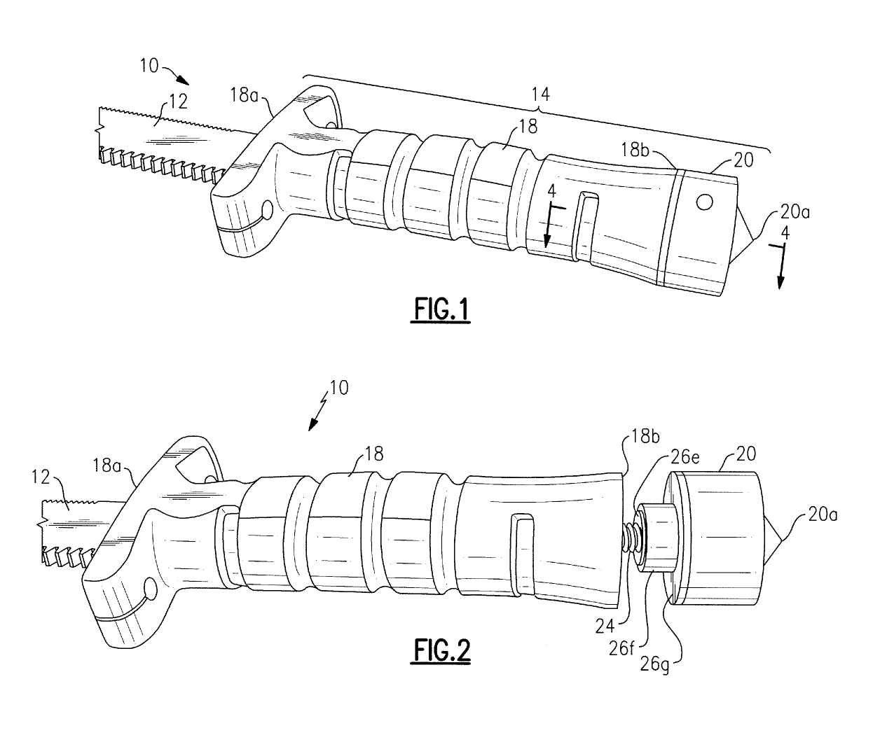

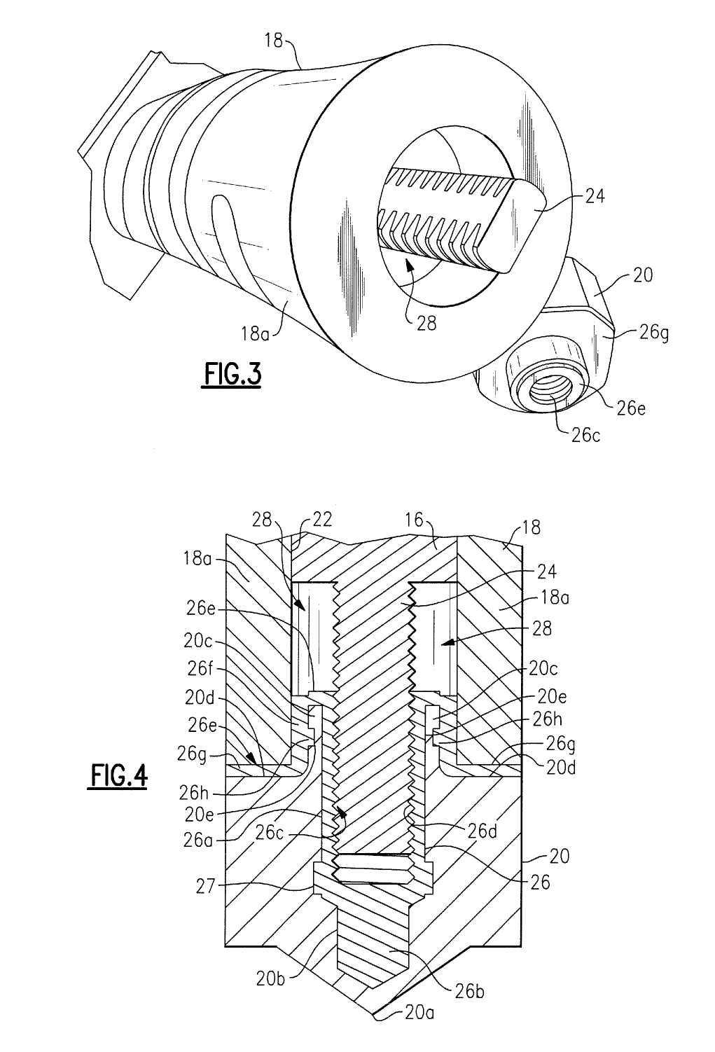

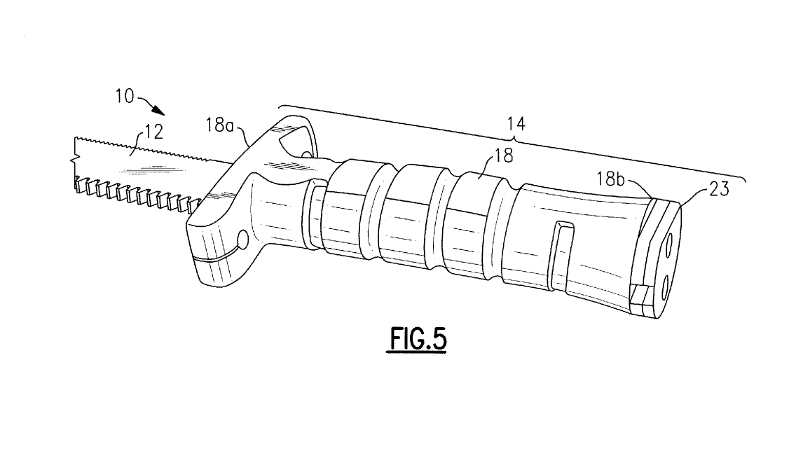

As seen best in FIGS. 2 and 4, handle grip 18 includes an opening 22 extending substantially axially along and entirely through the handle grip from the front end 18a to rear end 18b thereof. During assembly of the knife 10, blade extension 16 is inserted into opening 22 at handle grip front end 18a. Extension 16 includes an end piece coupling element at the end thereof opposite blade 12. In the embodiment shown in the drawing, the end piece coupling element is in the form of a threaded shank 24 which may be separately attached or integrally formed with extension 16.

Handle assembly 14 further includes an insert 26 made of an electrically insulating material such as plastic or rubber, for example. As seen best in FIG. 4, insert 26 forms a gasket-like seal between butt cap 20, handle grip 18, and coupling element 24. As such, insert 26 provides electric insulation between blade 12 and butt cap 20. Although the overall configuration of insert 26 may vary according to the design of the end piece and coupling element, in the embodiment of FIG. 4, insert 26 includes a central portion 26a terminating in a head 26b which is cooperatively formed to fit snugly within a central bore 20b formed in butt cap 20. The insert 26 also includes a central bore 26c formed through central portion 26a. Butt cap 20 and insert 26 are attached together by inserting central portion 26a into central bore 20b of butt cap 20. The insert central bore 26c is thus substantially axially aligned with butt cap central bore 20b. Insert central bore 26c may include threads 26d to engage the threaded shank 24 of extension 16 and in this way secure butt cap 20 to handle grip 18.

Insert 26 further includes a flange 26e which extends radially outwardly of central portion 26a. To provide a complete and uninterrupted electrically insulating barrier between butt cap 20 and blade 12 including extension 16 and coupling element 24, insert flange 26e follows the contour of and lies in complete covering relation to the surfaces of butt cap 20 which would contact handle grip 18 and extension 16. Referring still to FIG. 4, butt cap 20 is seen to include an annular neck portion 20c surrounded by an annular shoulder portion 20d. To follow this contour, insert flange 26c integrally extends from central portion 26a with an inner shoulder segment 26e which leads into a neck segment 26f which leads into an outer shoulder segment 26g.

As stated above, it is important that handle assembly 14 be water-tight since water entering the handle assembly could create an electric path that bypasses insert 26 causing a shock to the user at butt cap 20 should blade 12 come into contact with a source of electricity. In this regard, the insert-butt cap interface geometry is provided with a plurality of discontinuous, interfacing surfaces to create a tortuous path between the exterior and interior of handle assembly 14. For example, to create this geometry, insert annular neck portion 20c may include a squared notch 20e which interfaces with a squared flange 26h of insert 26. This squared notch-flange interface alone has three discontinuous, interfacing surfaces. Another benefit of this squared notch-flange interface is that it provides a very secure fit between insert 26 and butt cap 20. A second squared notch-flange interface 27 may be provided adjacent head portion 26b, for example, for added bond strength between these parts. Other insert-butt cap interface geometries are of course possible.

In one embodiment, the insert 26 is molded into butt cap 20 which, combined with the notch-flange interfaces, creates an extremely secure bond between these two parts. During assembly, butt cap 20 is screwed onto threaded shank 24 and a sealant may be provided at the interfacing surfaces of insert 26 and handle grip 18a to further ensure a watertight seal between the exterior and interior of handle assembly 14.

A portion 18a of handle grip 18 is radially spaced from coupling element 24 (or extension 16 in an embodiment where the coupling element does not extend outwardly of the insert central bore 26c) to form an air gap 28 therebetween. Insert shoulder segment 26e radially spans air gap 28 such that air gap 28 is an enclosed space, being defined by shoulder segment 26e, handle grip portion 18a, extension 16 and coupling element 24. The handle grip portion 18a is made of a material which can absorb the shock (by flexing, for example) of a force applied to any part of knife 10 including the extreme impact force received when using butt cap pointed end 20a to break through glass, for example. With air gap 28 and handle grip portion 18a absorbing these shocks, the integrity of the handle assembly and seal between insert 26, handle grip 16 and butt cap 20 is protected through the expected rigorous use of knife 10.

While the invention has been described with reference to particular embodiments thereof, it is understood that various modifications may be made thereto without departing from the full spirit and scope of the invention as defined by the claims which follow.

What is claimed is:

1. A knife assembly comprising:
a) a handle having first and second ends and an opening extending therebetween;
b) a blade having an extension including a coupling element at the end of said extension opposite said blade, said extension extending through said handle opening with said blade positioned adjacent said handle first end and said coupling element positioned adjacent said handle second end;
c) a handle end piece having a central opening and handle interface surfaces surrounding said central opening; and
d) an insert made of an electrically insulating material and including a central bore positioned in substantially coaxial alignment with said handle end piece central opening and in covering relation to said handle interface surfaces, said coupling element extending into said central bore and thereby securing said handle end piece to said handle with said insert electrically insulating said blade from said handle end piece.

2. The knife assembly of claim 1 wherein said handle end piece is a butt cap.

3. The knife assembly of claim 1 wherein said handle end piece is a bayonet latch.

4. The knife assembly of claim 1 wherein an internal air gap extends between said handle, said extension and said handle end piece.

5. The knife of claim 4 wherein the portion of said handle defining said air gap is made of a material which can flex and absorb the shock of a force applied to said handle end piece.

6. The knife assembly of claim 1 wherein said extension is the tang of the blade.

7. The knife assembly of claim 6 wherein said coupling element is integrally formed with said tang.

8. The knife assembly of claim 7 wherein said coupling element is a threaded shank.

9. The knife assembly of claim 2 wherein said butt cap includes a pointed end.

10. A tool assembly comprising:
a) a handle having first and second ends and an opening extending therebetween;
b) a tool having an extension including a coupling element at the end of said extension opposite said tool, said extension extending through said handle opening with said tool positioned adjacent said handle first end and said coupling element positioned adjacent said handle second end;
c) a handle end piece having a central opening and handle interface surfaces surrounding said central opening; and
d) an insert made of an electrically insulating material and including a central bore positioned in substantially coaxial alignment with said handle end piece central opening and in covering relation to said handle interface surfaces, said coupling element extending into said central bore and thereby securing said handle end piece to said handle with said insert electrically insulating said tool from said handle end piece.

11. The tool assembly of claim 10 wherein an internal air gap extends between said handle, said extension and said handle end piece.

12. The tool assembly of claim 11 wherein the portion of said handle defining said air gap is made of a material which can flex and absorb the shock of a force applied to said handle end piece.

13. The tool assembly of claim 12 wherein said tool is a knife blade.

14. A method of electrically insulating a metal tool from a metal handle end piece to which said tool is attached, said method comprising the steps of:
a) providing a handle having first and second ends and an opening extending therebetween;
b) providing a metal tool having an extension including a coupling element at the end of said extension opposite said tool;
c) extending said extension through said handle opening with said tool positioned adjacent said handle first end and said coupling element positioned adjacent said handle second end;
d) providing a metal handle end piece having a central opening and handle interface surfaces surrounding said central opening; and
e) providing an insert made of an electrically insulating material and including a central bore positioned in substantially coaxial alignment with said handle end piece central opening and in covering relation to said handle interface surfaces, said coupling element extending into said central bore and thereby securing said handle end piece to said handle with said insert electrically insulating said tool from said handle end piece.

15. The method of claim 14 wherein said handle end piece is a butt cap.

16. The method of claim 14 wherein said handle end piece is a bayonet latch.

17. The method of claim 14 wherein an internal air gap extends between said handle, said extension and said handle end piece.

18. The method of claim 17 wherein the portion of said handle defining said air gap is made of a material which can flex and absorb the shock of a force applied to said handle end piece.

19. The method of claim 14 wherein said extension is the tang of the blade.

20. The method of claim 19 wherein said coupling element is integrally formed with said tang.

21. The method of claim 20 wherein said coupling element is a threaded shank.

22. The method of claim 15 wherein said butt cap includes a pointed end.
